(19) United States
(12) Patent Application Publication
(10) Pub. No.: US 2009/0106221 A1
(43) Pub. Date: Apr. 23, 2009

(54) Ranking and Providing Search Results Based In Part On A Number Of Click-Through Features

(75) Inventors: Dmitriy Meyerzon, Bellevue, WA (US); Yauhen Shnitko, Redmond, WA (US); Michael J. Taylor, Cambridge (GB)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/874,579

(22) Filed: Oct. 18, 2007

(51) Int. Cl. G06F 17/30

(52) U.S. Cl. 707/5; 707/E17.108

(57) ABSTRACT

Embodiments are configured to provide information based on a user query. In an embodiment, a system includes a search component having a ranking component that can be used to rank search results as part of a query response. In one embodiment, the ranking component includes a ranking algorithm that can use one or more click-through features to rank search results which may be returned in response to a query. Other embodiments are available.

### RELATED APPLICATIONS

This application is related to U.S. patent application Ser. No. ______, filed Oct. 18, 2007, and entitled, “ENTERPRISE RELEVANCY RANKING USING A NEURAL NETWORK,” having docket number 14917.0715US01 which is hereby incorporated by reference in its entirety.

### BACKGROUND

Computer users have different ways to locate information that may be locally or remotely stored. For example, search engines can be used to locate documents and other files using keywords. Search engines can also be used to perform web-based queries. A search engine attempts to return relevant results based on a query.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are configured to provide information including using one or more ranking features when providing search results. In an embodiment, a system includes a search engine that includes a ranking algorithm that can be configured to use one or more click-through ranking features to rank and provide search results based on a query.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 depicts a block diagram of an example system configured to manage information.

FIG. 2 is a flow diagram depicting an example of a ranking and query process.

FIG. 3 is a flow diagram depicting an example of a ranking and query process.

FIG. 4 is a block diagram illustrating a computing environment for implementation of various embodiments described herein.

### DETAILED DESCRIPTION

Embodiments are configured to provide information including using one or more ranking features when providing search results. In an embodiment, a system includes a search engine that includes a ranking algorithm that can be configured to use one or more click-through ranking features to rank and provide search results based on a query. In one embodiment, a system includes a ranking component that can use a click parameter, a skip parameter, and one or more stream parameters to rank and provide a search result.

In one embodiment, a system includes a search component which comprises a searching application that can be included as part of a computer-readable storage medium. The searching application can be used to provide search results based in part on a user query and other user action and/or inaction. For example, a user can input keywords to the search application and the search application can use the keywords to return relevant search results. The user may or may not click on a search result for more information. As described below, the search application can use prior action and prior inaction based information when ranking and returning search results. Correspondingly, the search application can use user interactions based on a search result to provide additional focus when returning relevant search results. For example, the search application can use click-through information when ranking search results and returning the ranked search results based on a user query.

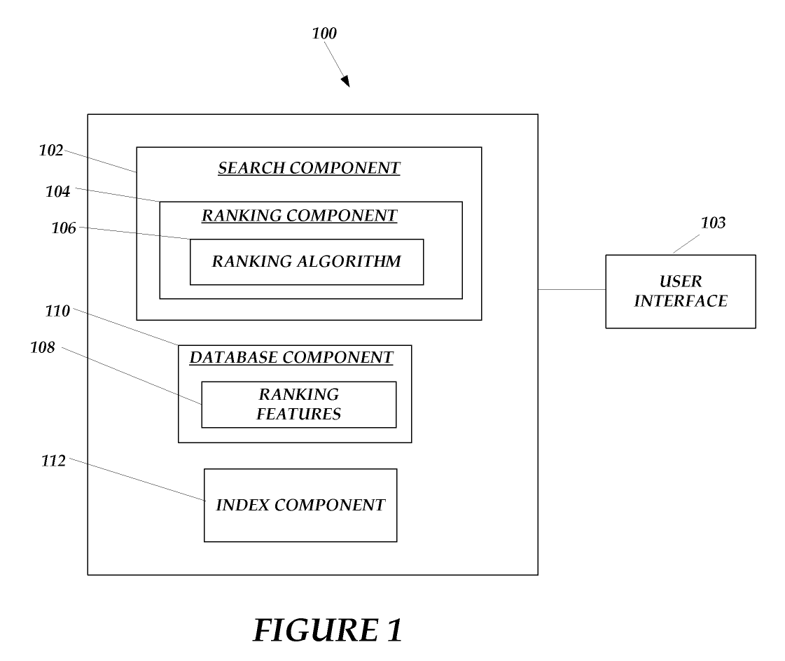

FIG. 1 is a block diagram of a system 100 which includes indexing, searching, and other functionality. For example, the system 100 can include indexing, searching, and other applications that can be used to index information as part of an indexed data structure and search for relevant data using the indexed data structure. As described below, components of the system 100 can be used to rank and return search results based at least in part on a query. For example, components of the system 100 can be configured to provide web-based search engine functionality that can be used to return search results to a user browser, based in part on a submitted query which may consist of one or more keywords, phrases, and other search items. A user can submit queries to the search component 102 using a user interface 103, such as a browser or search window for example.

As shown in FIG. 1, the system 100 includes a search component 102, such as a search engine for example, that can be configured to return results based in part on a query input. For example, the search component 102 can operate to use a word, words, phrases, concepts, and other data to locate relevant files, documents, web pages, and other information. The search component 102 can operate to locate information and can be used by an operating system (OS), file system, web-based system, or other system. The search component 102 can also be included as an add-in component, wherein the searching functionality can be used by a host system or application.

The search component 102 can be configured to provide search results (uniform resource locaters (URLs) for example) that may be associated with files, such as documents for example, file content, virtual content, web-based content, and other information. For example, the search component 102 may use text, property information, and/or metadata when returning search results associated with local files, remotely networked files, combinations of local and remote files, etc. In one embodiment, the search component 102 can interact with a file system, virtual web, network, or other information source when providing search results.

The search component 102 includes a ranking component 104 that can be configured to rank search results based at least in part on a ranking algorithm 106 and one or more ranking features 108. In one embodiment, the ranking algorithm 106 can be configured to provide a number or other variable that can be used for sorting purposes by the search component 102. The ranking features 108 can be described as basic inputs or raw numbers that can be used when identifying relevance of a search result. The ranking features 108 can be collected, stored, and maintained in a database component 110.

For example, the click-through ranking features can be stored and maintained using a number of query logging tables which can also contain query information associated with user queries. In an alternative embodiment, the ranking features 108 can be stored and maintained in a dedicated store, including local, remote, and other storage mediums. One or more of the ranking features 108 can be input to the ranking algorithm 106, and the ranking algorithm 106 can operate to rank search results as part of a ranking determination. As described below, in one embodiment, the ranking component 104 can manipulate one or more ranking features 108 as part of the ranking determination.

Correspondingly, the search component 102 can use the ranking component 104 and associated ranking algorithm 106 when using one or more of the ranking features 108 as part of a ranking determination to provide search results. Search results can be provided based on a relevance ranking or some other ranking. For example, the search component 102 can render the search results from most relevant to least relevant based at least in part on the relevance determination providing by the ranking component 104 using one or more of the ranking features 108.

With continuing reference to FIG. 1, the system 100 also includes an index component 112 that can be used to index information. The index component 112 can be used to index and catalog information to be stored in the database component 110. Moreover, the index component 102 can use the metadata, content, and/or other information when indexing against a number of disparate information sources. For example, the index component 112 can be used to build an inverted index data structure that maps keywords to documents, including URLs associated with documents.

The search component 102 can use the indexed information when returning relevant search results according to the ranking provided by the ranking component 104. In an embodiment, as part of a search, the search component 102 can be configured to identify a set of candidate results, such as a number of candidate documents for example, that contain a portion or all of a user's query information, such as keywords and phrases for example. For example, query information may be located in a document's body or metadata, or additional metadata associated with a document that can be stored in other documents or data stores (such as anchor text for example). As described below, rather than returning an entire set of search results if the set is large, the search component 102 can use the ranking component 104 to rank the candidates with respect to relevance or some other criteria, and return a subset of the entire set based at least in part on the ranking determination. However, if the set of candidates is not too large, the search component 102 can operate to return the entire set.

In an embodiment, the ranking component 104 can use the ranking algorithm 106 to predict a degree of relevance of a candidate associated with a particular query. For example, the ranking algorithm 106 can calculate a rank value associated with a candidate search result, wherein a higher rank value corresponds with a more relevant candidate. Multiple features, including one or more ranking features 108, can be input into the ranking algorithm 106 which can then compute an output that enables the search component 102 to sort candidates by a rank or some other criteria. The search component 102 can use the ranking algorithm 106 to prevent the user from having to inspect an entire set of candidates, such as large volume internet candidates and enterprise URL collections for example, by limiting a set of candidates according to rank.

In one embodiment, the search component 102 can monitor and collect action-based and/or inaction-based ranking features. The action-based and inaction-based ranking features can be stored in the database component 110 and updated as necessary. For example, click-through information, can be monitored and stored in the database component 110 as one or more ranking features 108 when a user interacts with, such as by clicking, a search result. The information can also be used to track when a user does not interact with a search result. For example, a user may skip over and not click on one or more search results. In an alternative embodiment, a separate component, such as an input detector or other recording component for example, can be used to monitor user interactions associated with a search result or results.

The search component 102 can use a select number of the collected action-based and inaction-based ranking features as part of a relevance determination when returning search results. In one embodiment, the search component 102 can collect and use a number of click-based interaction parameters as part of a relevance determination when returning search results based on a query. For example, assume that a user clicks on a search result (e.g., a document) that was not returned at the top of the results for whatever reason. As described below, the search component 102 can record and use the click feature to boost the rank of the clicked result the next time some user issues the same or a similar query. The search component 102 can also collect and use other interactive features and/or parameters, such as a touch input, pen input, and other affirmative user inputs.

In one embodiment, the search component 102 can use one or more click-through ranking features, wherein the one or more click-through ranking features can be derived from implicit user feedback. The click-through ranking features can be collected and stored, including updated features, in a number of query logging tables of the database component 110. For example, the search component 102 can use the functionality of an integrated server platform, such as MICROSOFT OFFICE SHAREPOINT SERVER® system, to collect, store, and update interaction-based features that can be used as part of a ranking determination. The functionality of the server platform can include web content management, enterprise content services, enterprise search, shared business processes, business intelligence services, and other services.

According to this embodiment, the search component 102 can use one or more click-through ranking features as part of a ranking determination when returning search results. The search component 102 can use prior click-through information when compiling the click-through ranking features which it can use to bias ranking orderings as part of a relevance determination. As described below, the one or more click-through ranking features can be used to provide a self-tunable ranking functionality by utilizing the implicit feedback a search result receives when a user interacts or does not interact with the search result. For example, a number of search results may be provided by the search component 102 listed by relevance on a search result page, and parameters can be collected based on whether the user clicks on a search result or skips a search result.

The search component 102 can use information in the database component 110, including stored action and/or inaction based features, when ranking and providing search results. The search component 102 can use query records and information associated with prior user actions or inactions associated with a query result when providing a current list of relevant results to a requester. For example, the search component 102 can use information associated with how other users have responded to prior search results (e.g., files, documents, feeds, etc.) in response to the same or similar queries when providing a current list of references based on an issued user query.

In one embodiment, the search component 102 can be used in conjunction with the functionality of a serving system, such as the MICROSOFT OFFICE SHAREPOINT SERVER® system, operating to record and use queries and/or query strings, record and use user actions and/or inactions associated with search results, and to record and use other information associated with a relevance determination. For example, the search component 102 can be used in conjunction with the functionality of the MICROSOFT OFFICE SHAREPOINT SERVER® system, to record and use issued queries along with a search result URL that may have been clicked for a particular query. The MICROSOFT OFFICE SHAREPOINT SERVER® system can also record a list of URLs that were shown or presented with a clicked URL, such as a number of URLs that were shown above a clicked URL for example,. Additionally, the MICROSOFT OFFICE SHAREPOINT SERVER® system can operate to record a search result URL that was not clicked based on a particular query. The click-through ranking features can be aggregated and used when making a relevance determination, described below.

In one embodiment, a number of click-through ranking features can be aggregated and defined as follows:

1) a click parameter, Nc, which corresponds with a number of times (across all queries) that a search result (e.g., a document, file, URL, etc.) was clicked.

2) a skip parameter, Ns, which corresponds with a number of times (across all queries) that a search result was skipped. That is, the search result was included with other search results, may have been observed by a user, but not clicked. For example, an observed or skipped search result may refer to a search result having a higher rank than a clicked result. In one embodiment, the search component 102 can use an assumption that a user scans search results from top to bottom when interacting with search results.

3) a first stream parameter, Pc, which can be represented as a text stream corresponding to a union of all query strings associated with a clicked search result. In one embodiment, the union includes all query strings for which a result was returned and clicked. Duplicates of the query strings are possible (i.e., every individual query can be used in the union operation).

4) a second stream parameter, Ps, which can be represented as a text stream corresponding to a union of all query strings associated with a skipped search result. In one embodiment, the union includes all query strings for which a result was returned and skipped. Duplicates of the query strings are possible (i.e., every individual query can be used in the union operation).

The above-listed click-through ranking features can be collected at a desired time, such as by one or more crawling systems on some periodic basis for example, and associated with each search result. For example, one or more of the click-through ranking features can be associated with a document which was returned by the search component 102 based on a user query. Thereafter, one or more of the click-through ranking features can be input to the ranking component 104 and used with the ranking algorithm 106 as part of the ranking and relevance determination. In some cases, some search results (e.g., documents, URLs, etc.) may not include click-through information. For search results with missing click-through information, certain text properties (e.g., Pc and/or Ps streams) may be left empty and certain static parameters (e.g., Nc and Ns) may have zero values.

In one embodiment, one or more of the click-through ranking features can be used with the ranking algorithm 106 which first requires collecting one or more click-through aggregates during a crawl, including full and/or incremental crawls. For example, the search component 102 can employ a crawler which can operate to crawl a file system, web-based collection, or other repository when collecting information associated with click-through ranking features and other data. One or more crawlers can be implemented for a crawl or crawls depending on the crawl target or targets and particular implementation.

The search component 102 can use the collected information, including any click-through ranking features, to update query independent stores, such as a number of query logging tables for example, with one or more features that can be used when ranking search results. For example, the search component 102 can update a number of query logging tables with the click (Nc) parameter and/or the skip (Ns) parameter for each search result that includes updated click-through information. Information associated with the updated query independent stores can be also used by various components, including the index component 102 when performing indexing operations.

Accordingly, the index component 112 can periodically obtain any changes or updates from one or more independent stores. Moreover, the index component 112 can periodically update one or more indexes which can include one or more dynamic and other features. In one embodiment, the system 100 can include two indexes, a main index and a secondary index for example, that the search component 102 can use to serve a query. The first (main) index can be used to index keywords from document bodies and/or metadata associated with web sites, file servers, and other information repositories. The secondary index can be used to index additional textual and static features that may not be directly obtained from a document. For example, additional textual and static features may include anchor text, click distance, click data, etc.

The secondary index also allows for separate update schedules. For example, when a new document is clicked, to index the associated data only requires partially rebuilding the secondary index. Thus, the main index can remain unchanged and the entire document does not require re-crawling. The main index structure can be structures as an inverted index and can be used to map keywords to document IDs, but is not so limited. For example, the index component 112 can update a secondary index using the first stream parameter Pc and/or the second stream parameter Ps for each search result that includes updated click-through information. Thereafter, one or more of the click-through ranking features and associated parameters can be applied and used by the search component 102, such as one or more inputs to the ranking algorithm 106 as part of a relevance determination associated with a query execution.

As described below, a two layer neural network can be used as part of a relevance determination. In one embodiment, the implementation of the two layer neural network includes a training phase and a ranking phase as part of a forward propagation process using the two layer neural network. A lambda ranking model can be used as a training algorithm (see C. Burges, R. Ragno, Q. V. Le, “Learning To Rank With Nonsmooth Cost Functions” in Scholkopf, Platt and Hofmann (Ed.) Advances in Neural Information Processing Systems 19, Proceedings of the 2006 Conference, (MIT Press, 2006) during the training phase, and a neural net forward propagation model can be used as part of the ranking determination. For example, a standard neural net forward propagation model can be used as part of the ranking phase. One or more of the click-through ranking features can be used in conjunction with the two layer neural network as part of a relevance determination when returning query results based on a user query.

In an embodiment, the ranking component 104 utilizes a ranking algorithm 106 which comprises a two layer neural network scoring function, hereinafter “scoring function,” which includes:

$$\begin{matrix}Score ( {x}_{1} , … , {x}_{n} ) = ( {\sum }_{j = 1}^{m} {h}_{j} \cdot w {2}_{j} ) \\ wherein , & ( 1 ) \\ {h}_{j} = tanh ( ( {\sum }_{i = 1}^{n} {x}_{i} \cdot {w}_{ij} ) + {t}_{j} ) & ( 1 a )\end{matrix}$$

wherein,

hⱼ is an output of hidden node j,

xᵢ is an input value from input node i, such as one or more ranking feature inputs,

w2ⱼ is a weight to be applied to a hidden node output,

wᵢⱼ is a weight to be applied to input value xᵢ by hidden node j,

tⱼ is the threshold value for hidden node j,

and, tanh is the hyperbolic tangent function:

$${h}_{j} = tanh ( ( {\sum }_{i = 1}^{n} {x}_{i} \cdot {w}_{ij} ) + {t}_{f} ) \qquad ( 1 c )$$

In an alternative embodiment, other functions having similar properties and characteristics as the tanh function can be used above. In one embodiment, the variable xᵢ can represent one or more click-through parameters. A λ-rank training algorithm can be used to train the two layer neural network scoring function before ranking as part of a relevance determination. Moreover, new features and parameters can be added to the scoring function without significantly affecting a training accuracy or training speed.

One or more ranking features 108 can be input and used by the ranking algorithm 106, the two layer neural network scoring function for this embodiment, when making a relevance determination when returning search results based on a user query. In one embodiment, one or more click-through ranking parameters (Nc, Ns, Pc, and/or Ps can be input and used by the ranking algorithm 106 when making a relevance determination as part of returning search results based on a user query.

The Nc parameter can be used to produce an additional input to the two layer neural net scoring function. In one embodiment, the input value associated with the Nc parameter can be calculated according to the following formula:

$$input = {x}_{{iN}_{c}} = \frac{( \frac{{N}_{c}}{{K}_{Nc} + {N}_{c}} - {M}_{Nc} )}{{S}_{Nc}} \qquad ( 2 )$$

wherein,

in one embodiment, the Nc parameter corresponds with a raw parameter value associated with a number of times (across all queries and all users) that a search result was clicked.

K_{Nc} is a tunable parameter (e.g., greater than or equal to zero).

M_{Nc} and S_{Nc} are mean and standard deviation parameters or normalization constants associated with training data, and,

iN_{c} corresponds with an index of an input mode.

The Ns parameter can be used to produce an additional input to the two layer neural net scoring function. In one embodiment, the input value associated with the Ns parameter can be calculated according to the following formula:

$$input = {x}_{{iN}_{c}} = \frac{( \frac{{N}_{c}}{{K}_{Nc} + {N}_{c}} - {M}_{Nc} )}{{S}_{Nc}} \qquad ( 3 )$$

wherein,

in one embodiment, the Ns parameter corresponds with a raw parameter value associated with a number of times (across all queries and all users) that a search result was skipped.

K_{Ns} is a tunable parameter (e.g., greater than or equal to zero),.

M_{Ns} and S_{Ns} are mean and standard deviation parameters or normalization constants associated with training data, and,.

iNₛ corresponds with an index of an input node.

The Pc parameter can be incorporated into the formula (4) below which can be used to produce a content dependent input to the two layer neural net scoring function.

$$\begin{matrix}input = {x}_{iBM {25}_{main}} \\ = BM 25 {G}_{main} ( Q , D ) \\ = \frac{( ( {\sum }_{t ∈ Q} \frac{{Tf}_{t}}{{k}_{2} + {TF}_{t}} \cdot log ( \frac{N}{{n}_{t}} ) ) - M )}{s}\end{matrix} \qquad ( 4 )$$

The formula for TF′ₜ can be calculated as follows:

$$TF \text{?} = ( \sum \text{?} TF \text{?} \cdot w \text{?} \cdot \frac{1 + b \text{?}}{( \frac{DL \text{?}}{AVDL \text{?}} + {b}_{p} )} ) + TF \text{?} \cdot w \text{?} \cdot \frac{1 + \text{?}}{( \frac{DL \text{?}}{AVDL \text{?}} + b \text{?} )} \\ \text{?} \text{indicates text missing or illegible when filed} \qquad ( 5 )$$

wherein,

Q is a query string,

t is an individual query term (e.g., word),

D is a result (e.g., document) being scored,

p is an individual property of a result (e.g., document) (for example, title, body, anchor text, author, etc. and any other textual property to be used for ranking,

N is a total number of results (e.g., documents) in a search domain,

nₜ is a number of results (e.g., documents) containing term t,

DLₚ is a length of the property p,

AVDLₚ is an average length of the property p,

TF_{t,p} is a term t frequency in the property p,

TF_{t,pc} corresponds to a number of times that a given term appears in the parameter Pc,

DL_{pc} corresponds with a length of the parameter Pc (e.g., the number of terms included),

AVDL_{pc} corresponds with an average length of the parameter Pc,

w_{pc} and b_{pc} correspond with tunable parameters,

D\Pc corresponds with a set of properties of a document D excluding property P_{c} (item for P_{c} is taken outside of the sum sign only for clarity),

iBM25main is an index of an input node, and,

M and S represent mean and standard deviation normalization constants.

The Ps parameter can be incorporated into the formula (6) below which can be used to produce an additional input to the two layer neural net scoring function.

$$\begin{matrix} input = \text{?} \\ where , & ( 6 ) \\ \text{?} \\ \text{?} \text{indicates text missing or illegible when filed} & ( 7 )\end{matrix}$$

and,

TF_{t,ps} represent a number of times that a given term is associated with the Ps parameter,

DLₚₛ represents a length of the Ps parameter (e.g., a number of terms),

AVDLₚₛ represents an average length of the Ps parameter,

N represents a number of search results (e.g., documents) in a corpus,

nₜ represents a number of search results (e.g., documents) containing a given query term,

k₁,wₚₛ,bₚₛ represent tunable parameters, and,

M and S represent mean and standard deviation normalization constants.

Once one or more of the inputs have been calculated as shown above, one or more of the inputs can be input into (1), and a score or ranking can be output which can then be used when ranking search results as part of the relevance determination. As an example, x₁ can be used to represent the calculated input associated with the Nc parameter, x₂ can be used to represent the calculated input associated with the Ns parameter, x₃ can be used to represent the calculated input associated with the Pc parameter, and, x₄ can be used to represent the calculated input associated with the Ps parameter. As described above, streams can also include body, title, author, URL, anchor text, generated title, and/or Pc. Accordingly, one or more inputs, e.g., x₁, x₂, x₃, and/or x₄ can be input into the scoring function (1) when ranking search results as part of the relevance determination. Correspondingly, the search component 102 can provide ranked search results to a user based on an issued query and one or more ranking inputs. For example, the search component 102 can return a set of URLs, wherein URLs within the set can be presented to the user based on a ranking order (e.g., high relevance value to low relevance value).

Other features can also be used when ranking and providing search results. In an embodiment, click distance (CD), URL depth (UD), file type or type prior (T), language or language prior (L), and/or other ranking features can be used to rank and provide search results. One or more of the additional ranking features can be used as part of a linear ranking determination, neural net determination, or other ranking determination. For example, one or more static ranking features can be used in conjunction with one or more dynamic ranking features as part of a linear ranking determination, neural net determination, or other ranking determination.

Accordingly, CD represents click distance, wherein CD can be described as a query-independent ranking feature that measures a number of “clicks” required to reach a given target, such as a page or document for example, from a reference location. CD takes advantage of a hierarchical structure of a system which may follow a tree structure, with a root node (e.g., the homepage) and subsequent branches extending to other nodes from that root. Viewing the tree as a graph, CD may be represented as the shortest path between the root, as reference location, and the given page. UD represents URL depth, wherein UD can be used to represent a count of the number of slashes (“/”) in a URL. T represents type prior, and, L represents language prior.

The T and L features can be used to represent enumerated data types. Examples of such a data type include file type and language type. As an example, for any given search domain, there may be a finite set of file types present and/or supported by the associated search engine. For example an enterprise intranet may contain word processing documents, spreadsheets, HTML web pages, and other documents. Each of these file types may have a different impact on the relevance of the associated document. An exemplary transformation can convert a file type value into a set of binary flags, one for each supported file type. Each of these flags can be used by a neural network individually so that each may be given a separate weight and processed separately. Language (in which the document is written) can be handled in a similar manner, with a single discrete binary flag used to indicate whether or not a document is written in a certain language. The sum of the term frequencies may also include body, title, author, anchor text, URL display name, extracted title, etc.

Ultimately, user satisfaction is one of surest measures of the operation of the search component 102. A user would prefer that the search component 102 quickly return the most relevant results, so that the user is not required to invest much time investigating a resulting set of candidates. For example, a metric evaluation can be used to determine a level of user satisfaction. In one embodiment, a metric evaluation can be improved by varying inputs to the ranking algorithm 106 or aspects of the ranking algorithm 106. A metric evaluation can be computed over some representative or random set of queries. For example, a representative set of queries can be selected based on a random sampling of queries contained in query logs stored in the database component 110. Relevance labels can be assigned to or associated with each result returned by the search component 102 for each of the metric evaluation queries.

For example, a metric evaluation may comprise an average count of relevant documents in the query at top N (1, 5, 10, etc.) results (also referred to as precision @1, 5, 10, etc.). As another example, a more complicated measure can be used to evaluate search results, such as an average precision or Normalized Discounted Cumulative Gain (NDCG). The NDCG can be described as a cumulative metric that allows multi-level judgments and penalizes the search component 102 for returning less relevant documents higher in the rank, and more relevant documents lower in the rank. A metric can be averaged over a query set to determine an overall accuracy quantification.

Continuing the NDCG example, for a given query “Qᵢ” the NDCG can be computed as:

$$M \text{?} {\sum }_{j = 1}^{N} ( 2 \text{?} - 1 ) / log ( 1 + j ) \\ \text{?} \text{indicates text missing or illegible when filed} \qquad ( 8 )$$

where N is typically 3 or 10. The metric can be averaged over a query set to determine an overall accuracy number.

Below are some experimental results obtained based on using the Nc, Ns, and Pc click-through parameters with the scoring function (1). Experiments were conducted on 10-splits query set (744 queries, ˜130K documents), 5-fold cross-validation run. For each fold, 6 splits were used for training, 2 for validation, and 2 for testing. A standard version of a λ-rank algorithm was used (see above).

Accordingly, aggregated results using 2-layer neural net scoring function with 4 hidden nodes resulted in the following as shown in Table 1 below:

TABLE 1

| Set of features | NDCG@1 | NDCG@3 | NDCG@10 |
|---|---|---|---|
| Baseline (no click- | 62.841 | 60.646 | 62.452 |
| through features) | | | |
| Incorporated N_{c}, Nₛ and | 64.598 (+2.8%) | 62.237 | 63.164 |
| P_{c} | | (+2.6%) | (+1.1%) |

The aggregated results using 2-layer neural net scoring function with 6 hidden nodes resulted in the following as shown in Table 2 below:

TABLE 2

| Set of features | NDCG@1 | NDCG@3 | NDCG@10 |
|---|---|---|---|
| Baseline (no click- | 62.661 | 60.899 | 62.373 |
| through) | | | |
| Incorporated N_{c}, Nₛ and | 65.447 (+4.4%) | 62.515 | 63.296 |
| P_{c} | | (+2.7%) | (+1.5%) |

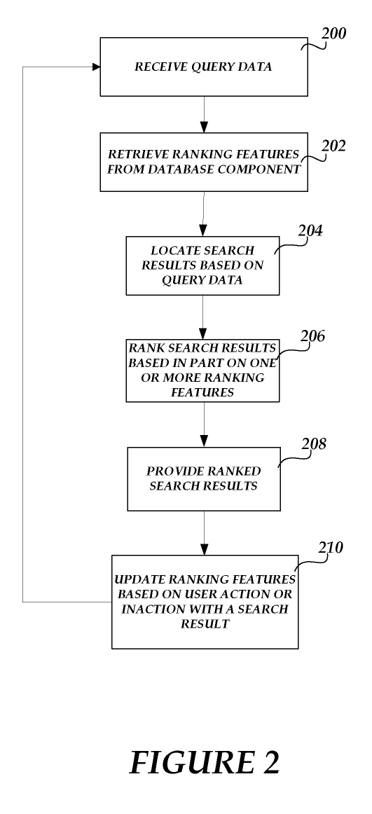

FIG. 2 is a flow diagram illustrating a process of providing information based in part on a user query, in accordance with an embodiment. Components of FIG. 1 are used in the description of FIG. 2, but the embodiment is not so limited. At 200, the search component 102 receives query data associated with a user query. For example, a user using a web-based browser can submit a text string consisting of a number of keywords which defines the user query. At 202, the search component 102 can communicate with the database component 110 to retrieve any ranking features 108 associated with the user query. For example, the search component 102 can retrieve one or more click-through ranking features from a number of query tables, wherein the one or more click-through ranking features are associated with previously issued queries having similar or identical keywords.

At 204, the search component 102 can use the user query to locate one or more search results. For example, the search component 102 can use a text string to locate documents, files, and other data structures associated with a file system, database, web-based collection, or some other information repository. At 206, the search component 102 uses one or more of the ranking features 108 to rank the search results. For example, the search component 102 can input one or more click-through ranking parameters to the scoring function (1) which can provide an output associated with a ranking for each search result.

At 208, the search component 102 can use the rankings to provide the search results to a user in a ranked order. For example, the search component 102 can provide a number of retrieved documents to a user, wherein the retrieved documents can be presented to the user according to a numerical ranking order (e.g., a descending order, ascending order, etc.). At 210, the search component 102 can use a user action or inaction associated with a search result to update one or more ranking features 108 which may be stored in the database component 10. For example, if a user clicked or skipped a URL search result, the search component 102 can push the click-through data (click data or skip data) to a number of query logging tables of the database component 110. Thereafter, the index component 112 can operate to use the updated ranking features for various indexing operations, including indexing operations associated with updating an indexed catalog of information.

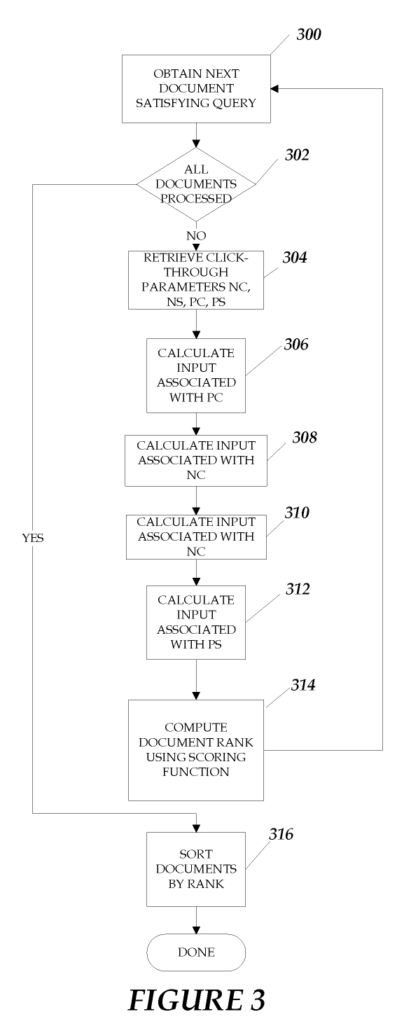

FIG. 3 is a flow diagram illustrating a process of providing information based in part on a user query, in accordance with an embodiment. Again, components of FIG. 1 are used in the description of FIG. 3, but the embodiment is not so limited. The process of FIG. 3 is subsequent to the search component 102 receiving a user query issued from the user interface 103, wherein the search component 102 has located a number of documents which satisfy the user query. For example, the search component 102 can use a number of submitted keywords to locate documents as part of a web-based search.

At 300, the search component 102 obtains a next document which satisfied the user query. If all documents have been located by the search component 102 at 302, the flow proceeds to 316, wherein the search component 102 can sort the located documents according to rank. If all documents have not been located at 302, the flow proceeds to 304 and the search component 102 retrieves any click-through features from the database component 110, wherein the retrieved click-through features are associated with the current document located by the search component 102.

At 306, the search component 102 can compute an input associated with the Pc parameter for use by the scoring function (1) as part of a ranking determination. For example, the search component 102 can input the Pc parameter into the formula (4) to compute an input associated with the Pc parameter. At 308, the search component 102 can compute a second input associated with the Nc parameter for use by the scoring function (1) as part of a ranking determination. For example, the search component 102 can input the Nc parameter into the formula (2) to compute an input associated with the Nc parameter.

At 310, the search component 102 can compute a third input associated with the Ns parameter for use by the scoring function (1) as part of a ranking determination. For example, the search component 102 can input the Ns parameter into the formula (3) to compute an input associated with the Ns parameter. At 312, the search component 102 can compute a fourth input associated with the Ps parameter for use by the scoring function (1) as part of a ranking determination. For example, the search component 102 can input the Ps parameter into the formula (6) to compute an input associated with the Ps parameter.

At 314, the search component 102 operates to input one or more of the calculated inputs into the scoring function (1) to compute a rank for the current document. In alternative embodiments, the search component 102 may instead calculate input values associated with select parameters, rather than calculating inputs for each click-through parameter. If there are no remaining documents to rank, at 316 the search component 102 sorts the documents by rank. For example, the search component 102 may sort the documents according to a descending rank order, starting with a document having a highest rank value and ending with a document having a lowest rank value. The search component 102 can also use the ranking as a cutoff to limit the number of results presented to the user. For example, the search component 102 may only present documents having a rank greater than X, when providing search results. Thereafter, the search component 102 can provide the sorted documents to a user for further action or inaction. While a certain order is described with respect to FIGS. 2 and 3, the order can be changed according to a desired implementation.

The embodiments and examples described herein are not intended to be limiting and other embodiments are available. Moreover, the components described above can be implemented as part of networked, distributed, or other computer-implemented environment. The components can communicate via a wired, wireless, and/or a combination of communication networks. A number of client computing devices, including desktop computers, laptops, handhelds, or other smart devices can interact with and/or be included as part of the system 100.

In alternative embodiments, the various components can be combined and/or configured according to a desired implementation. For example, the index component 112 can be included with the search component 102 as a single component for providing indexing and searching functionality. As additional example, neural networks can be implemented either in hardware or software. While certain embodiments include software implementations, they are not so limited and they encompass hardware, or mixed hardware/software solutions. Other embodiments and configurations are available.

### Exemplary Operating Environment

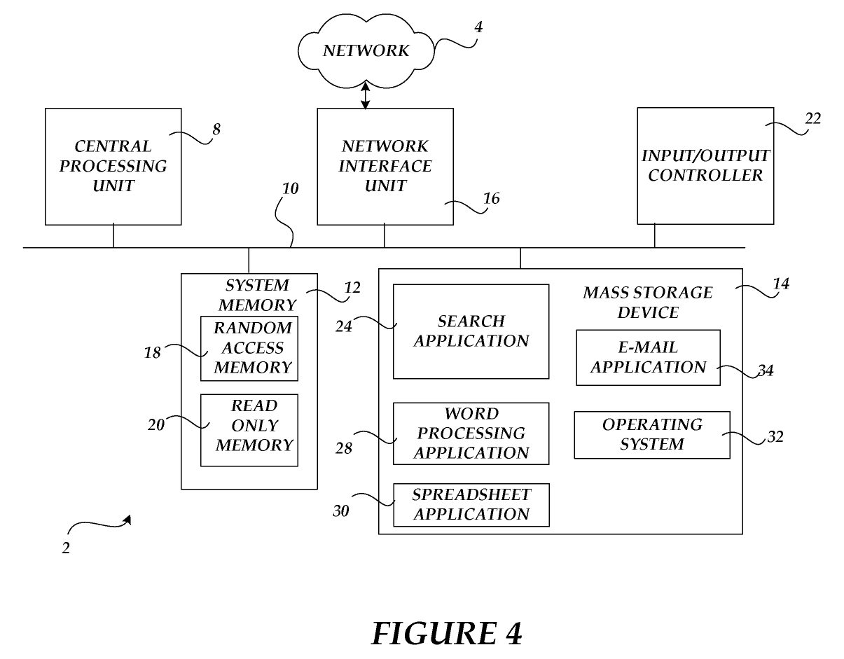

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a search application 24, word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A system for providing information comprising:
a search component configured to locate a search result based on a query input;
a database component configured to store information associated with the query input including one or more ranking features, wherein the one or more ranking features can be associated with a user action or user inaction associated with the search result which can be collected with respect to the search result for a same query or a similar query performed by prior users; and,
a ranking component configured to rank the search result based at least in part on a ranking function and the one or more ranking features, including an action-based feature and an inaction-based feature, wherein the search component can use the rank of the search result when providing search results according to a ranking order.

2. The system of claim 1, further comprising an index component configured to use the one or more updated ranking features when performing index operations associated with a search index.

3. The system of claim 1, wherein the one or more ranking features comprise one or more dynamic ranking features selected from a group consisting of body, title, author, generated title, an anchor text, and a URL.

4. The system of claim 1, wherein the one or more ranking features comprise one or more static ranking features selected from a group consisting of click distance, URL depth, file type, and language.

5. The system of claim 1, wherein the ranking function further comprises a scoring function defined as:
$$\begin{matrix}Score ( {x}_{1} , … , {x}_{n} ) = ( {\sum }_{j = 1}^{m} {h}_{j} \cdot w {2}_{j} ) \\ wherein , \\ {h}_{j} = tanh ( ( {\sum }_{i = 1}^{n} {x}_{i} \cdot {w}_{ij} ) + {t}_{j} )\end{matrix}$$
and,
xᵢ represents one or more inputs to the scoring function,
w2ⱼ represent weights of hidden nodes,
wᵢⱼ represent weights of the inputs,
tⱼ represent a number of thresholds, and,
tanh is a hyperbolic tangent function.

6. The system of claim 1, wherein the ranking component can use the one or more click-through parameters when ranking the search result, wherein the one or more click-through parameters further comprise one or more of the following:
a click parameter associated with a number of times that the search result has been clicked;
a skip parameter associated with a number of times that the search result has been skipped;
a first stream parameter corresponding to a union of query strings associated with a clicked search result; and,
a second stream parameter corresponding to a union of query strings associated with a skipped search result.

7. The system of claim 6, wherein the search component is further configured to update one or more of the click-through parameters including using information associated with how a user interacted with the search result when updating the one or more of the click-through parameters.

8. The system of claim 7, wherein the search component is further configured to update the one or more click-through parameters, wherein the update of the one or more click-through parameters corresponds with a selected search result or a skipped search result by a user.

9. The system of claim 1, wherein the wherein the one or more ranking features comprise one or more dynamic ranking features selected from a group consisting of body, title, author, generated title, an anchor text, and a URL, and one or more static ranking features selected from a group consisting of click distance, URL depth, file type, and language.

10. The system of claim 6, wherein the ranking component is further configured to calculate an input value associated with the click parameter, wherein the calculated input is defined as:
$$\text{?}$$
$$\text{?} \text{indicates text missing or illegible when filed}$$

11. The system of claim 6, wherein the search component is further configured to calculate an input value associated with the skip parameter, wherein the calculated input is defined as:
$$\text{?}$$
$$\text{?} \text{indicates text missing or illegible when filed}$$

12. The system of claim 6, wherein the search component is further configured to calculate an input value associated with the first stream parameter, wherein the calculated input is defined as:
$$\frac{( ( \sum \text{?} \cdot log ( \text{?} ) ) - M )}{S}$$
$$and , \\ \text{?}$$
$$\text{?} \text{indicates text missing or illegible when filed}$$

13. The system of claim 6, wherein the search component is further configured to calculate an input value associated with the second stream parameter, wherein the calculated input is defined as:
$$\frac{( ( \sum \text{?} \cdot log ( \text{?} ) ) - M )}{S}$$
$$and , \\ \text{?}$$
$$\text{?} \text{indicates text missing or illegible when filed}$$

14. A search engine configured to:
receive information associated with a query;
locate a search result associated with the query;
calculate a first input associated with a click parameter and the search result;
calculate a second input associated with a skip parameter and the search result; and,
rank the search result using the first and second inputs.

15. The search engine of claim 14, further configured to:
calculate a third input associated with a first stream parameter and the search result;
calculate a fourth input associated with a second stream parameter and the search result; and,
rank the search result using at least three of the first, second, third, and fourth inputs.

16. The search engine of claim 14, further configured to update a store with click parameter and skip parameter updates associated with user interactions with the search result.

17. The search engine of claim 14, further configured to update a store with stream parameter updates associated with user interactions with the search result.

18. A method of providing information comprising:
receiving a query which includes one or more keywords;
searching for a candidate based in part on the one or more keywords;
finding query candidates based in part on the one or more keywords;
determining a first input value associated with a prior user action and at least one of the query candidates;
determining a second input value associated with a prior user inaction and at least one of the query candidates; and,
ranking a set of the query candidates based in part on a scoring determination using a scoring function and one or more of the first and second input values.

19. The method of claim 18, further comprising:
determining a third input value associated with a text stream and a user selection of at least one of the query candidates; and
ranking the set of the query candidates based in part on a scoring determination using a scoring function and one or more of the first, second input, and third input values.

20. The method of claim 18, further comprising ranking a set of documents according to a numerical order.
